(19) United States
(12) Patent Application Publication
(10) Pub. No.: US 2014/0267793 A1
(43) Pub. Date: Sep. 18, 2014

(54) SYSTEM AND METHOD FOR VEHICLE RECOGNITION IN A DYNAMIC SETTING

(71) Applicants: Shaofei Wang, Irvine, CA (US); Bill Homan-Muise, Seal Beach, CA (US)

(72) Inventors: Shaofei Wang, Irvine, CA (US); Bill Homan-Muise, Seal Beach, CA (US)

(73) Assignee: DELPHI DISPLAY SYSTEMS, INC., Costa Mesa, CA (US)

(21) Appl. No.: 14/201,288

(22) Filed: Mar. 7, 2014

Related U.S. Application Data
(60) Provisional application No. 61/788,850, filed on Mar. 15, 2013.

(51) Int. Cl. H04N 5/232

(52) U.S. Cl. CPC H04N 5/23222
USPC 348/207.1

(57) ABSTRACT

A system and method for use with at least one internet protocol (IP) video camera, or other vision capture equipment to look for and identify vehicles passing a particular point or points in the drive thru lane and a retail establishment, such as, for example, a quick service restaurant.

### CROSS-REFERENCE TO RELATED APPLICATIONS

The present application claims priority to U.S. Provisional Application No. 61/788,850, filed Mar. 15, 2013, entitled System and Method for Vehicle Recognition in a Dynamic Setting, the entirety of which is incorporated by reference as if set forth herein.

### FIELD OF THE INVENTION

The present invention relates to vehicle identification, and, more particularly, to an system and method of identify vehicles passing a particular point or points in the drive thru lane using an IP-based camera or other visioning equipment and a system for analyzing unique visual characteristic that may be common to certain vehicles.

### BACKGROUND OF THE INVENTION

It is common for banks, pharmacies and restaurants to have “drive-thru” service lanes where customers can drive in, order their product or service, and have it delivered to them without leaving their vehicle. In particular restaurants accomplish this with multi-station drive thru lanes. One station may be for viewing the menu and placing the order, another may be for paying for the order, and yet another may be for picking up the purchased merchandise. Convenience and speed are the primary benefits of drive thru lane ordering and pickup.

For a drive thru lane to function properly, the workers in the store need to know when a vehicle is at each station in the drive thru lane so that they can interact with it appropriately. In addition, to ensure optimal speed of service for their customers, operators need to know the precise timing for each vehicle as it progresses from station to station in the drive thru lane.

In most drive thru lane installations, an inductive loop coil is buried in the pavement to send a signal when a vehicle rides over a particular location. Loops have three major drawbacks for use in drive thru lanes: 1) they cannot detect the direction of a vehicle that drives over it (they can only detect whether a vehicle is there or not); 2) since loops rely solely on the conductance of metal, they only detect the presence of metal, not if that metal is actually a vehicle (for example, the system can be “tricked” the system by waving large metal objects over the loop detector); 3) inductive loops cannot uniquely identify a particular vehicle in the drive thru lane; and 4) multi-lane drive thru configurations further complicate vehicle tracking when two or more lanes merge into one, it is difficult for a binary loop system to deduce which vehicle merged first.

Thus, there is a need in the market to better detect the presence and direction of unique vehicles in a drive thru lane, and to resolve ambiguities associated with timing vehicles entering and leaving multiple lane configurations.

### SUMMARY

The present invention provides a system for use with at least one internet protocol (IP) video camera or other vision capture equipment to look for and identify vehicles passing a particular point or points in the drive thru lane and a retail establishment, such as, for example, a fast food chain. The camera may be situated to look for a unique visual characteristic that is common to all vehicles.

It is to be understood that both the foregoing general description and the following detailed description are exemplary and explanatory, and are intended to provide further explanation of the invention as discussed hereinthroughout.

### BRIEF DESCRIPTION OF THE DRAWINGS

The accompanying drawings are included to provide a further understanding of the disclosed embodiments. In the drawings:

FIG. 1 is an illustration of aspects of the present invention;

FIG. 2 is an illustration of aspects of the present invention;

FIG. 3 is an illustration of aspects of the present invention;

FIG. 4 is an illustration of aspects of the present invention;

FIG. 5 is an illustration of aspects of the present invention;

FIG. 6 is an illustration of aspects of the present invention; and

FIG. 7 is an illustration of aspects of the present invention.

### DETAILED DESCRIPTION

A computer-implemented platform and methods of use are disclosed that provide networked access to a plurality of information, including but not limited to video and audio content, and that track and analyze captured video images. Described embodiments are intended to be exemplary and not limiting. As such, it is contemplated that the herein described systems and methods can be adapted to provide many types of vehicle identification and tracking systems, and can be extended to provide enhancements and/or additions to the exemplary services described. The invention is intended to include all such extensions. Reference will now be made in detail to various exemplary and illustrative embodiments of the present invention.

A system is contemplated that will use a computer and Internet Protocol (IP) video camera or other vision capture equipment to look for and identify vehicles passing a particular point or points in the drive thru lane. The camera will be situated to look for a unique visual characteristic that is common to all vehicles. For example, all vehicles found in a drive thru lane can be assumed to have wheels. Cameras would be located at one or many points of interest in the drive thru process, such as illustrated in FIG. 1. Similarly, a vehicle may unique visual characteristics which include, for example, magnets, such as those promoting a school, event and/or club, for example, which may be placed on a viewable side of the vehicle, such as, for example, the driver's side of the car, overhead profile and/or the rear of the vehicle.

As described herein throughout, the present invention may provide at least one processor, which may be located in at least one computer, connected to at least one camera able to take an image from the at least one camera and determine whether a vehicle's wheel or, other unique visual characteristic, is present in that image. The camera(s) may be connected to the one or more computers that would process the camera images to gain information about the position and progress of vehicles in the drive thru lane. Furthermore, the present invention may connect to at least one camera through various means including serial, video or Ethernet. As illustrated in FIG. 6, a camera may capture an image or a frame from a video feed with a frame grabber, for example.

The captured image may be in a standard form and may, for example, comprise a collection of pixels, as illustrated in FIG. 2, for example. As would be appreciated by those skilled in the art, various algorithms and methods may be employed to determine shapes in the array of image pixels using techniques, such as, for example, the Hough Transform. Similarly, the present invention may utilize various algorithms and methods are already known in the art to enhance the captured image through filtering and edge-detection techniques, such as Canny, for example, to identify graphic patterns in the image. The captured image may be modified by a number of software filters, as illustrated in FIG. 6, to remove background noise and enhance contrast, for example. A filtered image may also be passed to through an edge detection algorithm to identify possible 3D edges in the 2D image. The techniques discussed herein may identify candidate objects through a voting algorithm that compares image details with known geometric patterns.

If, for example, the present invention identifies a pattern in the image, such as, for example, a circle, the system may construct a Histogram of Oriented Gradients (HOG) template consisting of a number of small patches, such as illustrated in FIG. 3, which may mathematically describe the interrelation of the various pixels that make up the circular wheel image. The shape within an image may be described by the distribution of intensity gradients or edge directions. The descriptors may be achieved by dividing the image into small connected regions, called cells, and for each cell compiling a histogram of gradient directions or edge orientations for the pixels within the cell. A HOG template may define a discriminative representation of the wheel in the associated HOG feature space, matching the templates to the actual image, such as illustrated in FIG. 4.

Once the shape is defined in the HOG space, it may be processed by another machine learning application that incorporates classification technique, which may be, for example, a Support Vector Machine (SVM), as illustrated in FIG. 6, and/or a supervised classification algorithm in machine learning. Where a human identifies images that match the desired shape being searched, and the computer algorithm may “remember” the HOG templates.

As illustrated in FIG. 5, a classifier may look for an optimal hyperplane as a decision function. The SVM may separate the images into one of two possible classes, for example. The present invention may allow for the SVM to be “trained” to have as wide a gap as possible between the two classes while preserve maximum classification precision. Once trained on images containing some particular object, such as a wheel, for example, the classifier may make decisions regarding the presence of an object in newly obtained images besides the original training data.

The classifier may also be trained to create and store at least one sub-class related to at least one class of shapes. For example, wheels, may be grouped into unique sub-classes that uniquely represent a particular wheel. In this way the system may positively identify a particular vehicle in the drive thru lane by the unique pattern of shapes found in its wheels. By running the classifier multiple times, unique wheel shapes may be more readily identified by the invention.

The classifier may also be trained to sub-class a class of shapes, for example, wheels, into unique sub-classes that uniquely represent a particular wheel. In this way the system can positively identify a particular vehicle in the drive thru lane by the unique pattern of shapes found in its wheels. By running the classifier multiple times, unique wheel shapes may be identified by the invention.

Further, to identify a particular wheel after it has been rotated, the invention may locate robust visual elements that are not mutated by rotation or scaling. The present invention may incorporate such methods known to those skilled in the art, such as the Speed Up Robust Features (SURF) detection method, for example, to track the angle of rotation of key visual features in the image of the wheel. By computing the angle of rotation of the shape pattern via SURF, the system of the present invention may determine if the wheel shape has rotated clockwise or counter clockwise, ultimately determining if the vehicle has moved forward or backward in the drive thru lane.

Once a unique wheel shape is identified, as illustrated in FIG. 6, the information associated with such identification may be cataloged by the present invention and may be added to at least one storage system and/or database for subsequent comparison. A stored image may include event data such as camera number, location, as well as a computer generated time stamp, which may, for example, include date and time. Captured information such as this may be added to a list of known patterns held by the system. As will be appreciated by those skilled in the art, such information may be locally stored and/or shared across at least one network to at least one second remote location.

When a new image is received by the system from the same camera or another camera associated with the system, the system may process this new image as was done to the prior images and as discussed above. This may include, for example, capture, filtering, edge detection and graphic enhancement, circle shape detection, and/or HOG categorization. Once processed, any resulting new pattern(s) may be compared to other patterns including those that have been recently collected to search for a match.

As illustrated in FIG. 6, if a match is found, the system may use meta data associated with the new image, including a camera number, location and timestamp, for example, to calculate the time and distance between each instance of the identified pattern. The present invention may also store the new pattern in its matching list, such as within a database, to be used for comparison with subsequent image captures. In this way, the computer and camera or cameras would be able to monitor and track the vehicles progression from way-point to way-point through the drive-thru lane.

FIG. 7 depicts an exemplary computing system 100 for use in accordance with herein described system and methods. Computing system 100 is capable of executing software, such as an operating system (OS) and a variety of computing applications 190. The operation of exemplary computing system 100 is controlled primarily by computer readable instructions, such as instructions stored in a computer readable storage medium, such as hard disk drive (HDD) 115, optical disk (not shown) such as a CD or DVD, solid state drive (not shown) such as a USB “thumb drive,” or the like. Such instructions may be executed within central processing unit (CPU) 110 to cause computing system 100 to perform operations. In many known computer servers, workstations, personal computers, and the like, CPU 110 is implemented in an integrated circuit called a processor.

It is appreciated that, although exemplary computing system 100 is shown to comprise a single CPU 110, such description is merely illustrative as computing system 100 may comprise a plurality of CPUs 110. Additionally, computing system 100 may exploit the resources of remote CPUs (not shown), for example, through communications network 170 or some other data communications means.

In operation, CPU 110 fetches, decodes, and executes instructions from a computer readable storage medium such as HDD 115. Such instructions can be included in software such as an operating system (OS), executable programs, and the like. Information, such as computer instructions and other computer readable data, is transferred between components of computing system 100 via the system's main data-transfer path. The main data-transfer path may use a system bus architecture 105, although other computer architectures (not shown) can be used, such as architectures using serializers and deserializers and crossbar switches to communicate data between devices over serial communication paths. System bus 105 can include data lines for sending data, address lines for sending addresses, and control lines for sending interrupts and for operating the system bus. Some busses provide bus arbitration that regulates access to the bus by extension cards, controllers, and CPU 110. Devices that attach to the busses and arbitrate access to the bus are called bus masters. Bus master support also allows multiprocessor configurations of the busses to be created by the addition of bus master adapters containing processors and support chips.

Memory devices coupled to system bus 105 can include random access memory (RAM) 125 and read only memory (ROM) 130, non-volatile flash memory and other data storage hardware. Such memories include circuitry that allows information to be stored and retrieved. ROMs 130 generally contain stored data that cannot be modified. Data stored in RAM 125 can be read or changed by CPU 110 or other hardware devices. Access to RAM 125 and/or ROM 130 may be controlled by memory controller 120. Memory controller 120 may provide an address translation function that translates virtual addresses into physical addresses as instructions are executed. Memory controller 120 may also provide a memory protection function that isolates processes within the system and isolates system processes from user processes. Thus, a program running in user mode can normally access only memory mapped by its own process virtual address space; it cannot access memory within another process' virtual address space unless memory sharing between the processes has been set up.

In addition, computing system 100 may contain peripheral controller 135 responsible for communicating instructions using a peripheral bus from CPU 110 to peripherals, such as printer 140, keyboard 145, and mouse 150. An example of a peripheral bus is the Peripheral Component Interconnect (PCI) bus.

Display 160, which is controlled by display controller 155, can be used to display visual output and/or presentation generated by or at the request of computing system 100. Such visual output may include text, graphics, animated graphics, and/or video, for example. Display 160 may be implemented with a CRT-based video display, an LCD-based flat-panel display, gas plasma-based flat-panel display, touch-panel, or the like. Display controller 155 includes electronic components required to generate a video signal that is sent to display 160.

Further, computing system 100 may contain network adapter 165 which may be used to couple computing system 100 to an external communication network 170, which may include or provide access to the Internet. Communications network 170 may provide user access for computing system 100 with means of communicating and transferring software and information electronically. Additionally, communications network 170 may provide for distributed processing, which involves several computers and the sharing of workloads or cooperative efforts in performing a task. It is appreciated that the network connections shown are exemplary and other means of establishing communications links between computing system 100 and remote users may be used.

It is appreciated that exemplary computing system 100 is merely illustrative of a computing environment in which the herein described systems and methods may operate and does not limit the implementation of the herein described systems and methods in computing environments having differing components and configurations, as the inventive concepts described herein may be implemented in various computing environments using various components and configurations.

Those skilled in the art will appreciate that the herein described systems and methods are susceptible to various modifications and alternative constructions. There is no intention to limit the scope of the invention to the specific constructions described herein. Rather, the herein described systems and methods are intended to cover all modifications, alternative constructions, and equivalents falling within the scope and spirit of the invention and its equivalents.

What is claimed is:

1. A system for identifying a vehicle, comprising:
at least one camera communicatively connected to at least one network hub, computer or gateway device for capturing at least one image of a passing vehicle;
a network hub, computer or gateway device for creating at least one template consisting of a plurality of pixels from the at least one image; and
a database for storing the at least one template and a plurality of known templates associated with at least one prior passing vehicle;
wherein the at least one template is compared to ones of the plurality of known templates for the identification of at least one prior passing vehicle.

2. The system of claim 1, wherein the at least one template is a HOG template.

3. The system of claim 1, wherein the at least one image comprises a portion of the driver's side of the vehicle.

4. The system of claim 1, wherein the at least one image comprises a portion of the rear of the vehicle.

5. The system of claim 1, wherein the at least one image comprises a portion of the overhead view of the vehicle.

6. The system of claim 1, wherein the at least one image comprises at least one unique identifier.

7. The system of claim 1, wherein the identification of at least one prior passing vehicle is stored in association with the at least one template and at least ones of the plurality of known templates.

8. A method for identifying a vehicle, comprising:
providing, at least two locations, at least two cameras communicatively connected to at least one network hub, computer or gateway device for capturing at least two images of a passing vehicle;
creating at least two templates consisting of a plurality of pixels from the at least two images; and
storing on at least one database the at least two templates and a plurality of known templates associated with at least one prior passing vehicle;
wherein one of the at least two templates is compared to ones of the plurality of known templates for the identification of at least one prior passing vehicle.

9. The method of claim 8, wherein one of the at least two templates is a HOG template.

10. The method of claim 8, wherein one of the at least two images comprise at least a portion of one of the vehicle's wheels.

11. The method of claim 8, wherein one of the at least two images comprise at least one unique identifier.

12. The method of claim 8, wherein the identification of at least one prior passing vehicle is stored in association with one of the at least two templates and at least ones of the plurality of known templates.
